(19) United States
(12) Patent Application Publication
(10) Pub. No.: US 2008/0117290 A1
(43) Pub. Date: May 22, 2008

(54) Apparatus, system and method for generating stereoscopic images and correcting for vertical parallax

(75) Inventor: John D. Mazza, Pittsburgh, PA (US)

Correspondence Address: JAMES RAY & ASSOCIATES, 2640 PITCAIRN ROAD, MONROEVILLE, PA, 15146, US

(73) Assignee: MGC WORKS, INC.

(21) Appl. No.: 11/975,186

(22) Filed: Oct. 18, 2007

Related U.S. Application Data
(60) Provisional application No. 60/852,893, filed on Oct. 18, 2006.

(51) Int. Cl. H04N 13/02

(52) U.S. Cl. 348/47; 348/E13.074

(57) ABSTRACT

A stereoscopic imaging system for generating stereoscopic images includes a pair of cameras juxtaposed with each other in a horizontal plane each capturing a stream of video images. A controller is provided for controlling motion of each camera, determining presence of a vertical parallax between the images from each camera and converting such first and second video signal into said stereoscopic image of such object. A drive apparatus is provided for linearly moving one camera and for rotating the other camera in response to at least one control signal received from the controller thereby correcting for determined vertical parallax presence. The novel drive apparatus includes an electrically powered linear drive mechanism for moving the first camera and an electrically powered motor and gear arrangement for rotating the second camera. The images are analyzed in a generally real-time manner and image capture and generation is not blocked during analysis.

### CROSS-REFERENCE TO RELATED APPLICATIONS

This application is related to and claims priority from Provisional Patent Application Ser. No. 60/852,893 filed on Oct. 18, 2006.

### FIELD OF THE INVENTION

The present invention relates, in general, to stereoscopy and, more particularly, this invention relates to a stereoscopic imaging system capable of analyzing captured images and automatically aligning one camera in vertical direction relative to the other camera in order to maintain desirable image quality and resolution by correcting for vertical parallax, and yet more particularly, the instant invention relates to a method of generating stereoscopic images and to a method of correcting for vertical parallax.

### BACKGROUND OF THE INVENTION

As is generally well known, conventional two-dimensional (2D) photographs and videos are captured with a single lens, and result in a flat image of an object. However, nearly everyone actually sees the world through two points of view at once. The human brain takes the two images of a single object presented thereto by our two eyes and creates a single object that allows us to automatically detect depth and distance of the object. This condition is referred to as stereo vision, and any camera system that attempts to reproduce the effect is referred to as a stereo camera. The overall technique is referred to as three-dimensional (3D) imaging or stereoscopy.

Adding the “missing” third dimension to a photographic object has been a goal attempted with various degrees of success for over a century. Early on, it was found that taking a pair of photographs with cameras separated in a manner to maintain the geometric relationships of human eyes could result in a true (3D) image representation of the object. The downside of this approach was in that specialized techniques and exacting measurements were required when taking the photographs and when preparing them for viewing with special equipment.

Early experiments in 3D imaging required that the two photographs be mounted side-by-side and be viewed through a specialized arrangement of lenses to present the proper image to each eye. Since the technology of the time was rather primitive, this required very painstaking attention to detail and was quite error prone. Also, the requirement for a bulky single-person viewer naturally limited the technique to being practical and available for only a small portion of the general public.

As it is further well known, any stereoscopic camera system must conform to the human brain's expectations regarding the relationships of focal length, separation between viewpoints (known as stereo base) and image alignment. When properly done, the result is an image that is totally convincing to the viewer as representing object in three dimensions, as if the viewer was physically viewing the object in person as opposed to looking at a traditional 2D image of the object.

Thus, the stereoscopic imaging requires the capture of two views of the object to obtain the images to be presented to the viewer's eyes. The cameras used in capturing two views are best to be separated by a horizontal distance that depends upon object geometry and camera zoom settings.

When each camera lens is zoomed onto the object, any manufacturing defects due to tolerances will result in one camera's lens pointing slightly higher or lower than the other camera's lens. This condition results in a vertical misalignment that greatly reduces the quality of the captured stereoscopic imaging, and may make it impossible for the viewer to fuse images captured by each lens into a single coherent image.

While horizontal separation of the cameras is essential to provide the two views required for a stereo photograph to achieve its goal of simulating the viewing of a real object, any vertical misalignment of the two views is unacceptable to the human brain. This vertical misalignment is well known as vertical parallax.

Its presence will result in effects ranging from an apparent loss of resolution in very mild cases, to eyestrain and headaches in moderate cases, to a complete failure of the viewer to merge the individual views into a coherent image in more extreme cases. Therefore, efforts must be made to correct for vertical parallax in any practical stereoscopic imaging camera system.

Prior to the design and conception of the present invention, various attempts have been made to correct or compensate for vertical parallax.

In a camera design where the camera lenses are of a fixed focal length and the camera separation is rigidly fixed, correction for vertical parallax can be achieved at the time of manufacture of the camera. However, any camera that provides for a zoom lens of varying focal length and/or provides for variable type of the stereo base will invariably have minor errors due to manufacturing tolerances in the actual direction in which the optical center of the lens aligns with the body of the camera as the lens is zoomed, or slight shifts in alignment as the cameras are separated from one another. This results in both varying horizontal and vertical parallax. The caused horizontal parallax is not generally objectionable, as it merely adds to or subtracts from the true stereo base that the cameras are set to, but the vertical parallax is immediately noticeable to the viewer of the resultant image.

Vertical parallax may be removed from a highly specialized stereoscopic camera by the proper use of cams or screws that vertically tilt the lenses slightly in relation to one another as they are zoomed. Such design requires that the entire system is built from scratch as a dedicated mechanical assembly consisting of the lenses, mechanical zoom components, and image detectors. Use of commodity (off the shelf) cameras is not possible in such a system, and the design requires extremely accurate behavior characterization of each lens to provide the proper offsets.

### SUMMARY OF THE INVENTION

According to one aspect, the invention provides a stereoscopic imaging system for generating stereoscopic images of an object from a combination of a first video signal representative of a stream of first input image frames of such object which are captured by a first camera and a second video signal representative of a stream of second input image frames of such object which are captured by a second camera independently from such first camera. The second camera is juxtaposed with such first camera in a horizontal plane. The system includes a control means coupled to such first and second camera for receiving such first and second video signal, determining presence of a vertical parallax therebetween and converting such first and second video signal into the stereoscopic image of such object. A drive means is connected to such first and second camera and is coupled to the control means for rotating, in a vertical plane, one of such first and second camera in response to at least one control signal received from the control means thereby correcting for the vertical parallax presence determined by the control means.

According to another aspect of the invention, there is provided an apparatus for correcting for a vertical parallax in stereoscopic images of an object generated from a first video signal representative of a stream of first input image frames of such object which are captured by a first camera and a second video signal representative of a stream of second input image frames of such object which are captured by a second camera independently from such first camera, such second camera being juxtaposed with such first camera in a horizontal plane. The apparatus includes a first drive means which is coupled to such first camera for at least enabling linear movement thereof relative to such second camera. The apparatus also includes a second drive means which is coupled to such second camera for tilting such second camera in a vertical plane.

According to yet another aspect, the invention provides a method of correcting for a vertical parallax in stereoscopic images of an object generated from a combination of a first video signal representative of a stream of first input image frames of the object which are captured by a first camera and a second video signal representative of a stream of second input image frames of the object which are captured by a second camera independently from the first camera, the second camera being juxtaposed with the first camera in a horizontal plane. The method includes the step of receiving, by a control means, the first video signal and the second video signal. Then, analyzing, with the control means, the first input image frames and the second input image frames. Next, calculating, with the control means, a value of the vertical parallax between corresponding first input image frames and the second input image frames. Generating, with the control means, a correction control signal corresponding to the determined vertical parallax. Then, receiving the correction control signal at a drive means coupled to the control means and connected to one of the first and second camera. Finally, tilting one of the first and second cameras, by the drive means, in a vertical plane and in a direction which is opposite to the direction of the determined vertical parallax.

According to a further aspect of the invention, there is provided a method of generating at least one stereoscopic image. The method includes the step of positioning a first and a second camera in a horizontal plane. Then, generating, with the first camera, a first signal representative of a first input image of the object. Also, generating, with the second camera, a second signal representative of a second input image of the object. Next, analyzing, by the control means, the first signal and the second signal. Determining, by the control means, a vertical parallax between the first signal and the second signal. Finally, tilting one of the first and the second camera to correct the determined vertical parallax.

### OBJECTS OF THE INVENTION

It is, therefore, one of the primary objects of the present invention to provide a stereoscopic imaging system for generating stereoscopic images from independent images captured by a pair of spaced apart cameras.

Another object of the present invention is to provide a stereoscopic imaging system that is capable of analyzing images captured from each camera.

Yet another object of the present invention is to provide a stereoscopic imaging system that analyzes such captured images in a generally real-time fashion.

A further object of the present invention is to provide a stereoscopic imaging system that determines presence of a vertical parallax.

Yet a further object of the present invention is to provide a stereoscopic imaging system that includes an apparatus capable of tilting at least one camera in a vertical plane for correcting for vertical parallax.

An additional object of the present invention is to provide a stereoscopic imaging system that is usable in full-motion and still-image applications.

Another object of the present invention is to provide a method of capturing, analyzing and generating stereoscopic images.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a functional block diagram of a stereoscopic imaging system of the present invention;

FIG. 2 is a perspective view of the stereoscopic imaging system of FIG. 1, particularly illustrating such system in a fully assembled condition;

FIG. 3 is a perspective view of the stereoscopic imaging system of FIG. 2, particularly illustrating an apparatus for linearly moving one camera in a horizontal plane and tilting another camera in a vertical plane;

FIG. 4 is a partial front perspective view of the apparatus of FIG. 3;

FIG. 5 is a partial perspective view of the apparatus of FIG. 3, particularly illustrating a drive means for linearly moving one camera;

FIG. 6 is a partial rear perspective view of the apparatus of FIG. 3;

FIG. 7 is a partial front elevation view of the apparatus of FIG. 3, particularly illustrating a drive means for tilting another camera; and

FIGS. 8a-8d are graphical representations of the vertical parallax correction method employed by the stereoscopic imaging system of FIG. 1 for generating stereoscopic images.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

The present invention overcomes disadvantages of the prior art stereoscopic imaging system by employing a pair of cameras which may have varying degrees of misalignment as they are zoomed onto an object to be captured and analyzing the resultant video images in real-time fashion to determine the value and direction, if any, of vertical parallax. This parallax information is then employed to tilt one camera about an axis that is perpendicular to the optical axis of its lens to align its image in the vertical plane with the image from the other camera.

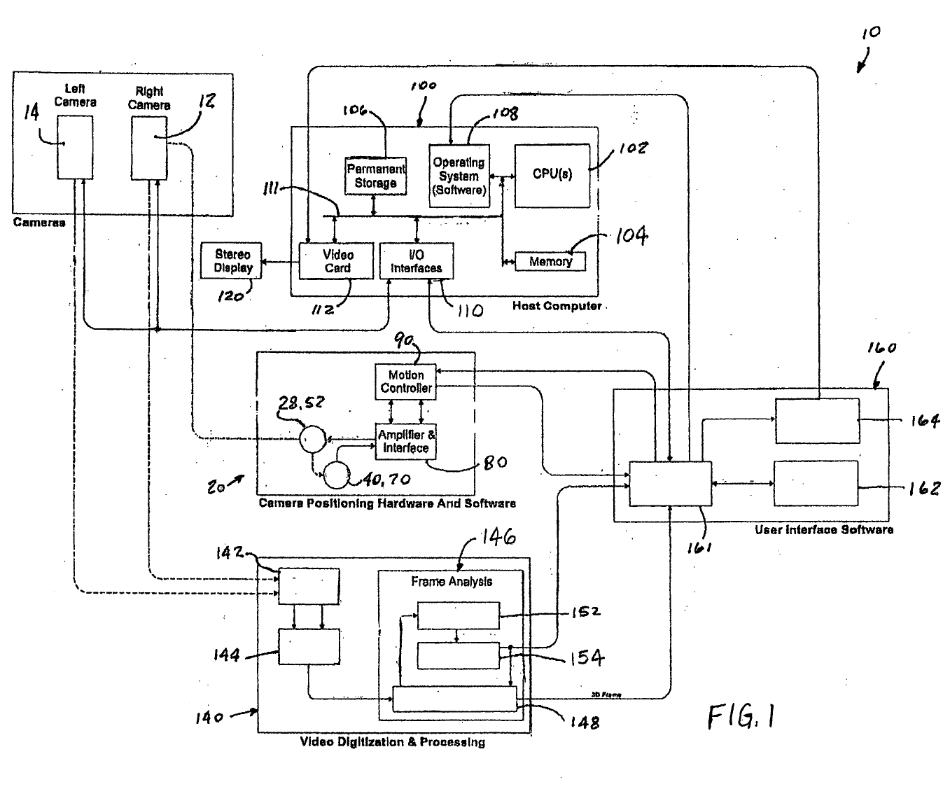

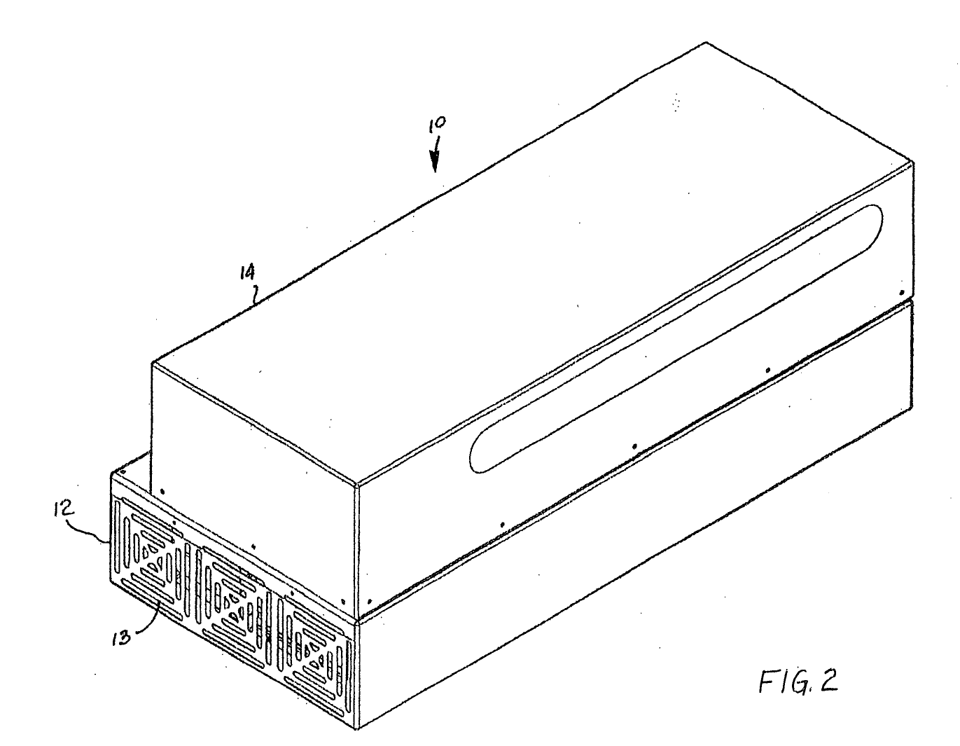

The best mode for carrying out the invention is presented in terms of its presently preferred embodiment, herein depicted within FIGS. 1 through 8d. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Now in reference to FIGS. 1-3, there is shown a stereoscopic imaging system, generally designated as 10, for generating stereoscopic images of an object 2 from a combination of first signal from a first camera 12 having a lens 13 and a second signal from a second camera 14 having a lens 15. The cameras 12, 14 are juxtaposed with each other in a horizontal plane with optical axis of each lens 13, 15 being substantially parallel to one another. Each lens 13, 15 may be of a zoom type. It is presently preferred that such first camera 12 and such second 14 are substantially identical. It is within the scope of the present invention to employ the stereoscopic imaging system 10 with any available camera 12, 14 generating either analog or digital video signal or may include such cameras 12, 14.

The present invention is illustrated and described with each of first and second signal being a video signal representative of a stream of input image frames, although it will be apparent to those skilled in the relevant art that, since the video signal stream is essentially succession of still image frames, the present invention may be applied to a single still stereographic image and as such should not be interpreted as a limiting factor of the stereoscopic imaging system 10 of the present invention.

The stereoscopic imaging system 10 essentially includes a control means coupled to such first and second camera, 12 and 14 respectively, for receiving such first and second video signal, determining presence of a vertical parallax therebetween and converting such first and second video signal into the stereoscopic image of such object 2; and a drive means, generally designated as 20, which is connected to such first and second camera, 12 and 14 respectively, and which is coupled to the control means for tilting, in a vertical plane, one of such first and second camera in response to at least one control signal received from the control means thereby correcting for the vertical parallax presence determined by the control means.

Although the present invention is illustrated and described in terms of linearly moving the first camera 12 and tilting the second camera 14, it will be apparent to those skilled in the art, that the movements of the cameras 12, 14 may be reversed in the present invention, the first camera 12 may be adapted for both linear and tilting movements or both cameras 12, 14 may be simultaneously tilted in opposite directions.

The control means, which may be a conventional computer, is mounted within the housing 12 having at least one ventilation grill 13. A flanged base member 16 is preferably affixed to the top surface of the housing 12 and a cover member 14 is detachably attached to the base member 16 for selectively covering and uncovering apparatus 20 and cameras 12, 14.

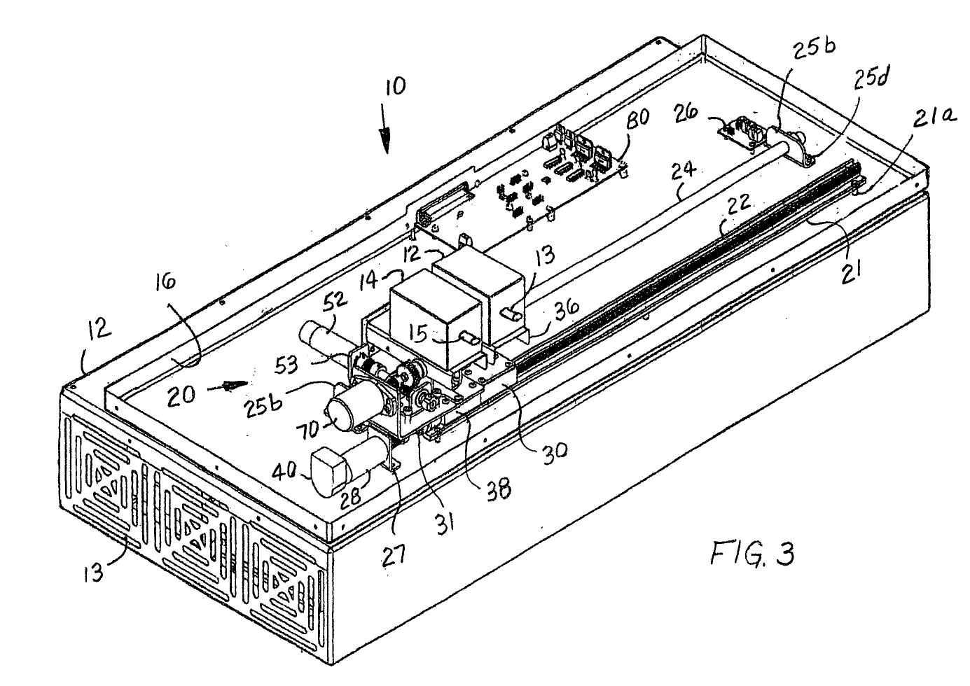

Now in reference to FIGS. 3-7, the apparatus 20 includes a first drive means which is coupled to such first camera 12 for at least enabling linear movement thereof relative to such second camera 14 in order to achieve the aforementioned stereo base between two viewpoints of the object 2 and a second drive means coupled to such second camera 14 for tilting such second camera 14 in a vertical plane.

The first drive means includes a first elongated guide member 22, a second elongated guide member 24 which is fixed in spaced and parallel relationship to the first guide member 22 and a camera mount assembly having a first end thereof operably engaging the first elongated guide member 22 and having a second end thereof operably engaging the second elongated guide member 24. Both the first elongated guide member 22 and the second elongated guide member 24 are mounted in a horizontal plane and are further mounted substantially perpendicular to the optical axis of each lens 13, 15. According to one embodiment of the invention, such first elongated guide member 22 and the second elongated guide member 24 may be simple cylindrical rods at least enabling the user of the system 10 to manually move the first camera 12 in a linear direction toward and away from the second camera 14 for capturing image of a particular object 2.

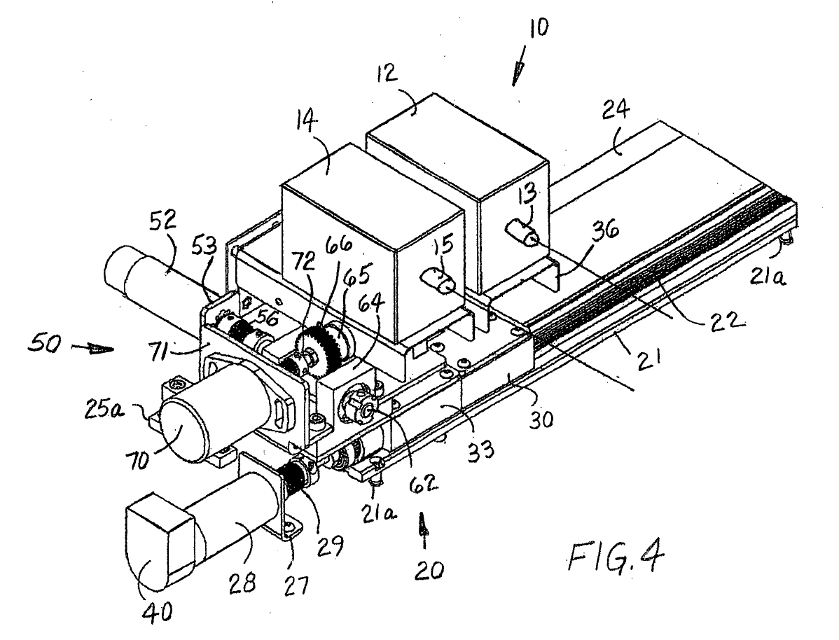

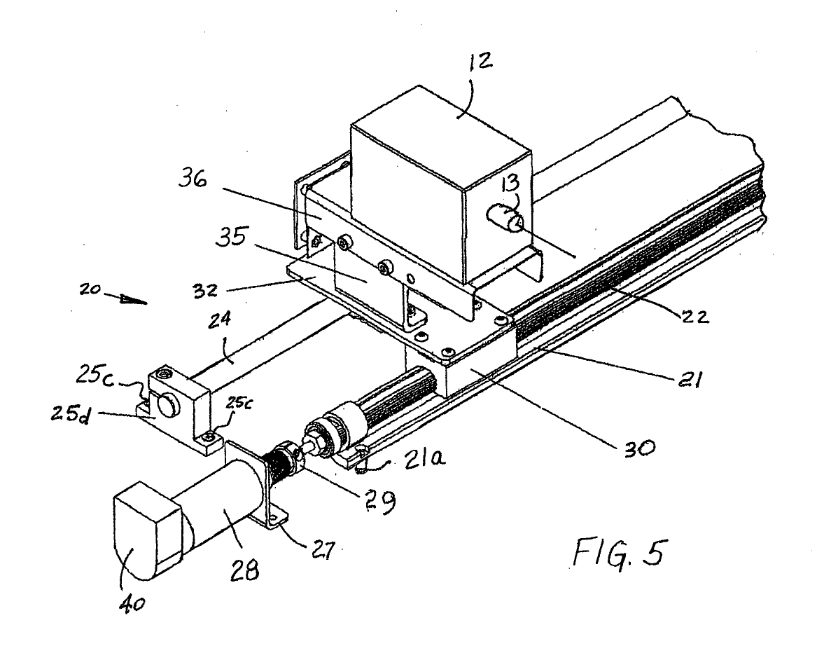

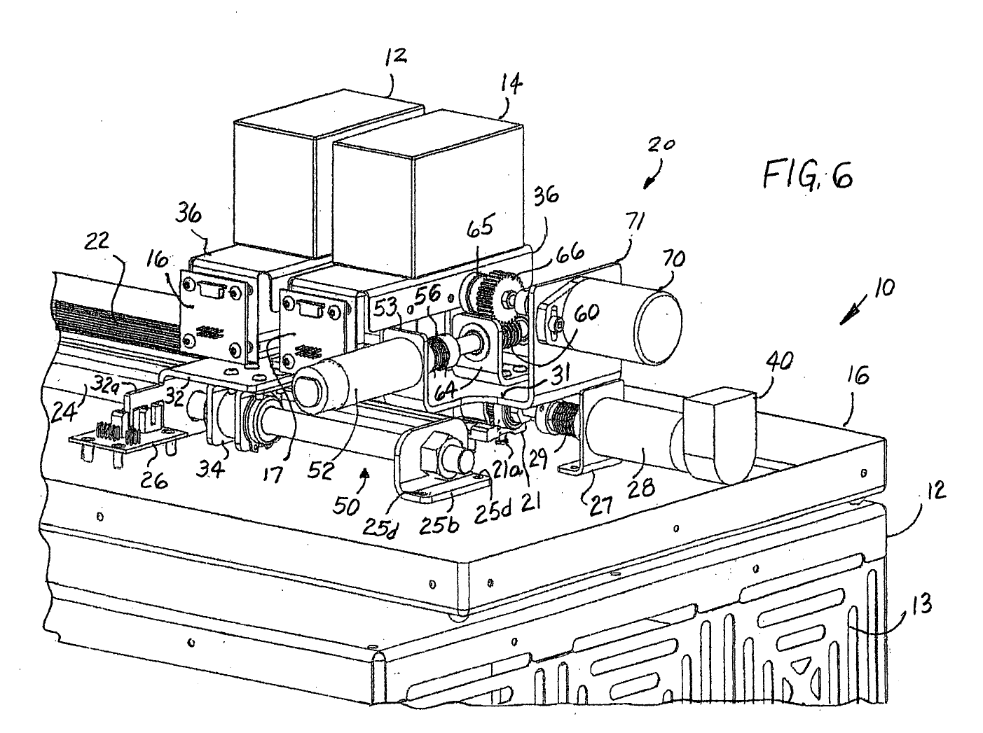

In accordance with a presently preferred embodiment of the invention, the first elongated guide member 22 is a conventional drive screw and the second elongated guide member 24 is a cylindrical rod. Accordingly, an elongated support 21 is provided for mounting the drive screw 22 in spaced relationship to the base member 16 by way of spacers 21a. The cylindrical rod 24 may be supported by a pair of clamps 25a, best shown in FIGS. 4-5, or by a pair of simple brackets 25b, best shown in FIGS. 3 and 6, which are attached to the base member 16 with conventional threaded fasteners 25c or 25d respectively.

The mount assembly for the first camera 12 includes a horizontally disposed first mount 32. A drive nut 30 which operably cooperates with the drive screw 22 is attached to one end of the mount 32 and is dispose din abutting relationship with the support 21 which prevents rotation of the drive nut 30 during linear movement of the first camera 12. A guide bushing or bearing 34 operably cooperating with the cylindrical rod 24 is attached to an opposed end of the first mount 32. The mount assembly also includes a riser 35 which is secured to the first mount 32 and a camera bracket 36 which is secured to the riser 35. Thus, the first camera 12 is attached to the camera bracket 36 in a spaced relationship with the first mount 32 and with the optical axis of its lens 13 being disposed horizontally and substantially perpendicular to the longitudinal axis of the drive screw 22.

There is also provided a powered drive including a first motor 28, preferably of an electric type, which is supported by a motor support 27 rigidly secured to the base member 16. The first motor 28 is coupled to one end of the drive screw 22 with a conventional coupling 29. In operation, the first motor 28 rotates the drive screw 22 either in clockwise or counter-clockwise direction upon receipt of a control signal causing reciprocal and linear movement of the drive nut 30 and, more particularly, enabling linear movement of the first camera 12 in a horizontal direction relative to the second camera 14. A sensor 40, such as an optical encoder, is preferably attached to a free end of the first motor 28 for providing a first positional signal characterizing a linear displacement of the first camera 12 relative to the second camera 14. The first positional signal may be of analog or quadrature-encoded digital signal type and preferably measures the rotation of the first motor 28.

A pair of optional stop means 26 is affixed to the base member 16 in spaced relationship with each other and adjacent each end of the cylindrical rod 24. The first mount 32 is adapted with a vertically disposed flange 32a, best shown in FIG. 6, which cooperates with the stop means 26 for limiting linear movement of the first camera 12.

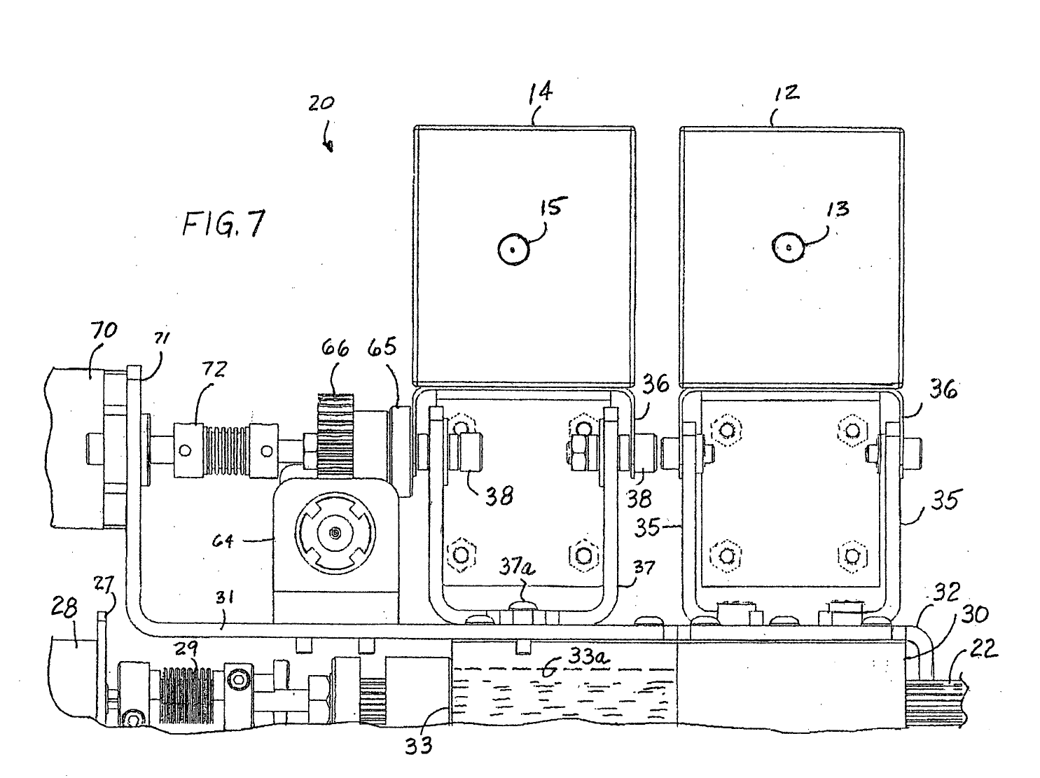

The second drive means, generally designated as 50, includes a shaft 65 which is disposed horizontally and substantially perpendicular to optical axis of the lens 15 of the second camera 14. A mount assembly for the second camera 14 is provided and is mounted for rotation about a longitudinal axis of the shaft 35. Now in further reference to FIG. 7, such mount assembly includes a second mount 31 which is stationary connected by a block 33 to the base member 16. A clearance aperture 33a is formed through the block 33 and disposed coaxially with drive screw 22 for enabling free rotation of such drive screw 22 during linear movement of the first camera 12. A U-shaped bracket 37 is secured to the second mount 31 with threaded fasteners 37a. A pair of bearings 38 are provided with each bearing 38 secured to a respective vertical flange of the U-shaped bracket 37 and in axial alignment with the shaft 65. The camera bracket 36 is pivotally mounted to the U-shaped bracket 37 at bearings 38. A powered drive assembly is provided and tilts the second camera 14 in a rotational manner and in the vertical plane about the axis of the shaft 65 to align the image captured by the second camera 14, also in the vertical plane, with the image captured by the first camera 12. The powered drive assembly 50 includes a second motor 52 which is affixed to a motor mount 53 so that the output shaft of the motor 52 is disposed horizontally and perpendicular to the rotational axis of the shaft 65. The motor mount 53 is preferably a vertical flange formed integral to the second mount 31. A coupling means 56 is provided and connects the output shaft of the second motor 52 with one end of a shaft 62 of a first gear 60. The ends of the shaft 62 are mounted for rotation within a pair of bearing blocks 64 so that the shaft 62 and, more particularly, the gear 60 rotates about a horizontally disposed longitudinal axis thereof. A second gear 66 disposed in a vertical plane and is secured to the shaft 65. The teeth of the second gear 66 cooperate with the teeth of the first gear 60 so that when the first gear 60 is rotated in the horizontal plane by the second motor 52, the second gear 66 incrementally rotates in a vertical plane causing like rotation or tilting of the second camera 14. A position sensor 70 which is supported by a mount 71 is coupled to the second gear 66 by way of the coupling means 72 for providing a second positional signal indicating tilt of the second camera 14 in the vertical plane relative to the first camera 12 which is then used in aligning the second camera 14. The second positional signal may be of analog or quadrature-encoded digital signal type and preferably measures the rotation of the second motor 52. The mount 71 is also preferably formed integral with the second mount 31.

The reader's attention is directed back to FIG. 1, wherein is depicted the control means of the present invention. Such control means includes an amplifier and interface module 80 which supplies power and rotational control signals to the motors 28, 52 and which provides positional signals of the cameras 12, 14, measured in current values, by the sensors 40 and 70 respectively to a motion control module 90. The amplifier and interface module 80 may be mounted within the enclosure 12 or may be attached to the base member 16, as depicted in FIG. 3.

The motion control module 90 transmits the positional values of the cameras 12, 14 to at least one Central Processing Unit (CPU) 102 of the main computing means, generally designated as 100, through an input/output interface module 110. The motion control module 90 also converts motion commands sent thereto by the main computing means 100 into an analog or pulse width modulated electrical rotational control signals which are transmitted to motors 28, 52, through the amplifier and interface module 80. Each motor 28, 52 then rotates either clockwise or counter-clockwise in response to such rotational control signals.

In a conventional manner, the main computing means 100 also includes a first memory module 104 of a random access and read only type, a second memory module 106 of a permanent storage type, and an operating system software module 108, all interconnected by way of a data buss 111.

An optional video card module 112 may be provided for connecting the main computing means 100 to an optional display 120 which may be of a stereo type for displaying captured stereographic images of the object 2. Alternatively or in combination to the display 120, the stereographic images of the object 2 are saved to the second memory module 106.

The main computing means 100 may be a conventional Personal Computer (PC) running a commonly available Operating System such as Microsoft Windows or Linux, or may be a proprietary custom design, preferably of a microprocessor type. It provides a basic platform for the execution of program code that controls the operation of the overall stereoscopic imaging system 10.

The stereoscopic imaging system 10 also provides for a video image processing means, generally designated as 140, which, in accordance with a presently preferred embodiment of the invention, includes multiplexer software module 144 that receives the two video data signals from cameras 12, 14 by way of the camera interfaces 16, 17 and merges them into a single stream of video data that contains both video data signals. It will be appreciated that each video signal is representative of a stream of sequential input image frames of such object which is captured by a respective camera. This merged video data stream is hereafter referred to as stereoscopic image.

When the video data signals are of an analog type, the image processing means 140 includes a video digitizing module 142, which first converts such single analog output signal from a respective camera 12, 14 into a digital stream of bytes that represents the image and then passes such digital signal to the multiplexer module 144. A frame analysis module 146 is provided to analyze the image to determine if any vertical parallax exists between the left and right images that it consists of. If any vertical parallax exists, it saves a value indicating the magnitude and direction of the vertical parallax for use by the motion control subsystem, and notifies either the user interface means, generally designated as 160, or the motion control module 90 to begin rotating the second motor 52 and tilting the second camera 14.

The user interface means 160 provides the user with a real-time view of the captured and aligned stereoscopic image, by way of an alignment control and monitoring module 161 and a viewfinder 164 to monitor the captured stereo video and set zoom settings, other camera parameters, and object composition with the user control portion 162.

The amplifier and interface module 80, motion control module 90, main computing means 100, video digitizing module 142, multiplexer module 144, and user interface means 160 are well known in the art and do not constitute a novel aspect of the present invention; accordingly, a more detailed description of the same is believed to be unnecessary and has been omitted.

In operation, to generate at least one stereoscopic image, the user positions the stereoscopic imaging system 10 to capture image of the object 2 and determines the optimum horizontal spacing between the cameras 12 and 14. To achieve such optimum spacing, the user employs a portion of the user controls 162 provided within the user interface 160 to enable the motion control module 90 to energize the first motor 28 through the amplifier and interface module 80 thus moving the first camera 12 toward to and/or away from the second camera 14. The user is aided by the viewfinder 164 to monitor the image of the object 2 received from cameras 12 and 14. When the sufficient perspective and clarity of the object image has been achieved, the user discontinues movement of the camera 12 and the horizontal spacing between the cameras 12, 14 is fixed, in a temporary manner, unless the user is tasked with selecting another object.

While achieving the optimum horizontal spacing between the cameras 12, 14, the user may activate such cameras 12, 14 to start capturing video images of the object 2. Accordingly, the first camera 12 generates a first video signal representative of a first input image of the object 2 while the second camera 14 generates a second video signal representative of a second input image of the object 2. However, it is within the scope of the present invention to activate cameras 12, 14 and start analysis of the captured images after the optimum horizontal spacing between the cameras 12, 14 has been achieved and set.

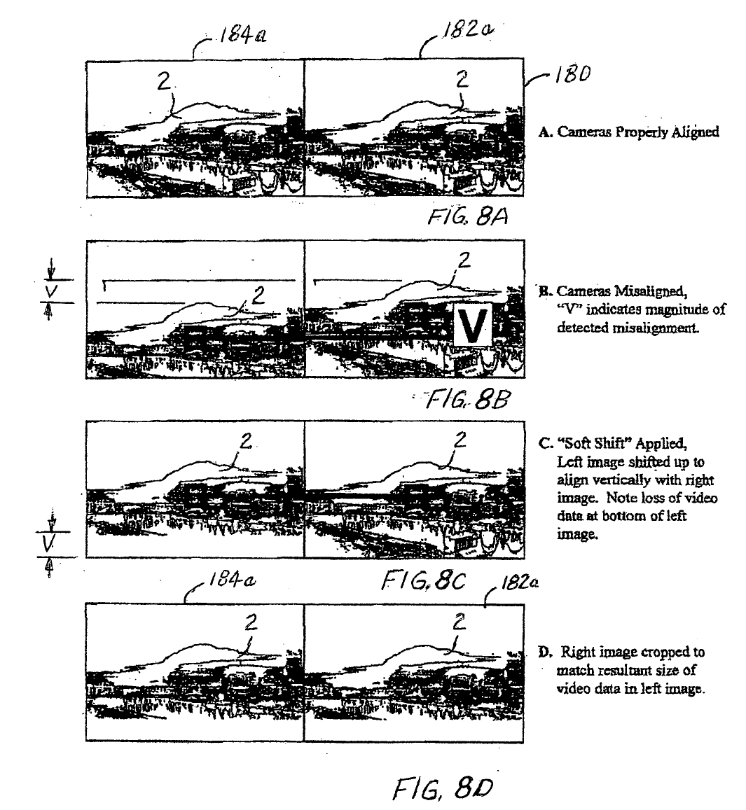

The first and second video signals are then analyzed by the control means and, more particularly, by the frame analysis module 146. Each first and second video signal may be analyzed independently, but as was noted above, corresponding image frames from such first and second video are first merged by the multiplexer module 144 into a single image frame 180. This step is hereinafter referred to as the 3D frame. By way of an example of FIG. 8A, the 3D frame 180 contains image portion 182a captured by the first camera 12 and image portion 184a captured by the second camera 14. It will be understood, that continuous stream of video data is essentially a succession of still image frames received at a predetermined rate depending on type of the camera 12, 14 connected to the stereoscopic imaging system 10. The rate is characterized as number of frames per second and the stereoscopic imaging system 10 is capable of operating with any presently employed image capture rates. Although, the image portions 182a and 184a are depicted in a side-by-side horizontal format, it will be apparent that other conventional formats, such as vertical, diagonal and overlay, may be employed in the present invention.

Each 3D frame 180, in a digital format, is then passed to the system's frame analysis module 146, which determines a vertical parallax between the first signal and the second signal and, more particularly, the vertical parallax between the image portions 182a and 184a of the 3D frame 180.

To determine the vertical parallax, the current 3D frame 180 is preferably first copied to a separate memory buffer module 148 so as to provide for a non-blocking and real-time display of each 3D frame 180 on the display 120 or for saving such 3D frame 180 to memory 106. The copy of the 3D frame 180 is then passed to the edge detection module 152 that converts each right and left image portion, 182a and 184a respectively, of the 3D frame 180 data into a new bitmap image that consists of the outline of objects in the 3D frame 180. As it is well known, the edge of any image is represented by a contrast between black pixels defining the image and white pixels defining the empty space and thus the edge detection module 152 uses such contrast to detect a suitable edge. Such conversion and detection may be performed by any suitable edge-detection algorithm, for example such as Sobel. The conversion enables matching correlations by subsequent analysis functions. Next, the copy of the current 3D frame 180 having detected edge is passed to the offset analysis module 154, whose main purpose is to determine the vertical misalignment (offset) between the right and left image portions, 182a and 184a respectively. The offset analysis starts by examining the portion of the right image portion 182a having such detected edge and moving progressively left, right, up, and down until a region is found whose characteristics are deemed suitable for further detection operations. For example, such suitable characteristics may include an irregular shape or a curve.

When the suitable region is found in the right image 182a, the software algorithm is then instructed to search for a region in the left image portion 184a that corresponds to matches the detected region's pattern in the right image portion 182a as closely as possible. If such region is detected in the left image portion 184a, the software algorithm subtracts the original coordinate value of this region's vertical position from the coordinate value of the vertical position of the right image 182a corresponding region to calculate a value of a vertical offset V, best shown in FIG. 8B, that indicates the magnitude (number of pixels) and direction of vertical misalignment that exists in the currently analyzed copy of the 3D frame 180. It will be appreciated that such vertical misalignment or offset V constitutes vertical parallax.

It must be noted that if no suitable matching region is detected, any further analysis of the current copy of the 3D frame 180 is abandoned and system's vertical alignment value is left unchanged either from a default value or from the value derived by the analysis of the previous 3D frame 180. This approach is advantageous in reducing sensitivity of the stereoscopic imaging system 10 to video noise and possible “jumpiness” in the video's vertical alignment that could result from objects 2 that are not possible to analyze, for example due to a low light condition.

If and only if the offset analysis is completed by detecting matching regions in both the right and left image portions, 182a and 184a respectively, of the current copy of the 3D frame 180, the current Vertical Alignment Value stored within the alignment control and monitoring module 161 is updated with the value of the detected offset V, the offset analysis module 154 generates an alignment error signal corresponding to such vertical parallax which is passed onto the alignment control and monitoring module 161. The later then generates a correction control signal which is passed onto the motion control module 90. This correction control signal is then received by the second motor 52 which tilts the second camera 14 in a vertical plane in a direction which is opposite to the direction of the vertical parallax and at a speed which is proportional to the detected vertical parallax. Alternatively, the user interface means 160 may be programmed to enable the user of the stereoscopic imaging system 10 to manually issue commands tilting the second camera 14 with the user control module 162 and through the alignment control and monitoring module 161. It must be noted that the motion control module 90 advantageously provides positional feedback to the alignment control and monitoring module 161. The function of the alignment control and monitoring module 161 can be achieved by way of a software, for example by way of Microsoft DirectShow “transform filter” or written in any programming language; hardware, for example such as a field programmable logic array (FPGA) or dedicated application specific integrated circuit (ASIC); and various combinations thereof.

When the analysis of the current copy of the 3D frame 180 has been completed, the system's frame analysis module 146 starts analysis of the copy of the next 3D frame 180. If analysis of the current 3D frame 180 has not been completed, the system's frame analysis module 146 completes it by using a detected vertical alignment value from the last analysis or by using a default value.

The system's frame analysis module 146 may also perform an optional image correction process, hereinafter referred to as the soft shift, which may be enabled or disabled by the user of the stereoscopic imaging system 10. Now in a particular reference to FIG. 8C, the left image portion 184a of the current copy of the 3D frame 180 is shifted upwardly by the value of the saved vertical offset V. The right image portion 182a is then cropped to match resulting left image portion 184a, as best shown in FIG. 8D. This shift results in a slightly degraded 3D frame 180, but also results in a faster alignment within the 3D frame 180 during tilting of the second camera 14 and further results in an economical manner of performing such alignment.

Although, the present invention has been described in terms of shifting the left image portion 184a, it will be apparent to those skilled in the art that the right image portion 182a may be equally shifted during analysis.

It is very important to note that the design of the stereoscopic imaging system 10 provides for the analysis of the captured images which does not block the flow of 3D frames 180 either to the display 120 or to the second memory 106. Furthermore, any analysis may be a very CPU intensive operation that can easily result in dropped video frames if it can't be completed before the next 3D frames 180 arrives from the multiplexer analysis module 144. To prevent such occurrence, the stereoscopic imaging system 10 is designed to only start the analysis on a present copy of the 3D frame 180 by the frame analysis module 146 when there is no other analysis running. With sufficiently fast inputting hardware, this will result in analysis still being performed on every 3D frame 180, and with slower inputting hardware it will run on a subset of the 3D frame 180.

It is well known that with any stereoscopic imaging system 10 containing lenses 13, 15 of a zoom type that have a variable focal length, the captured image will have a magnification value that depends on the focal length setting of the lens 13, 15. This magnification value not only enlarges or reduces the apparent size of the objects captured by the stereoscopic imaging system 10, but it also directly magnifies the effect of any camera movement by the same amount. Therefore, knowledge of the current optical magnification of the system is useful in determining the speed at which to rotate the second motor 52 for aligning the second camera 14 with the first camera 12 in the vertical direction. Accordingly, in the presently preferred embodiment of the invention, the stereoscopic imaging system 10 contains a base speed at which to physically tilt the second camera 14 that is divided by the net magnification factor of the lens 15 to ensure that the physical tilt is performed at an appropriate speed rate to help prevent “overshooting” the best alignment value. Furthermore, it is within the scope of the present invention to divide the base rate by a factor dependent not only on magnification factor of the lens 15, but also by the amount of detected vertical offset or misalignment V which is continuously updated within the alignment control and monitoring module 161, such that the rotational speed of the second motor 52 is fastest at low magnification and high vertical offset V, and slowest at high magnification and small vertical offset V conditions.

The stereoscopic imaging system 10 is continuously receiving and processing video frames, and possesses knowledge of the currently commanded lens zoom position through interface module 110 and the alignment control and monitoring module 161, the vertical misalignment V value is combined with the magnification factor to determine the speed at which to command the vertical tilt motion of the second camera 14. This speed is updated continuously as frames are analyzed.

Additionally, the present invention contemplates adding a threshold function whereby the calculated vertical misalignment V is compared to and predetermined small values of such vertical misalignment V are tolerated, especially if the video images contain any noise that reduces the reliability of any detection measurements. This approach provides the advantages of rapidly correcting large amounts of vertical misalignment while providing for very fine control of small misalignments, and greatly reducing the possibility of the system oscillating around a proper vertical alignment condition.

Although the present invention has been described in terms of a sequential frame by frame analysis, it is within the scope of the present invention to employ Proportional Integral Derivative (PID) techniques during the analysis of image frame in order to correct for vertical parallax.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A stereoscopic imaging system for generating stereoscopic images of an object from a combination of a first video signal representative of a stream of first input image frames of such object which are captured by a first camera and a second video signal representative of a stream of second input image frames of such object which are captured by a second camera independently from such first camera, such second camera being juxtaposed with such first camera in a horizontal plane, said system comprising:
(a) a control means coupled to such first and second camera for receiving such first and second video signal, determining presence of a vertical parallax therebetween and converting such first and second video signal into said stereoscopic image of such object; and
(b) a drive means connected to such first and second camera and operably coupled to said control means for tilting, in a vertical plane, one of such first and second camera in response to at least one control signal received from said control means thereby correcting for said vertical parallax presence determined by said control means.

2. The system, according to claim 1, wherein said system includes a display means for displaying said stereoscopic image.

3. The system, according to claim 1, wherein said system includes a user interface means for manually controlling operation of said drive means and for viewing said stereoscopic image.

4. The system, according to claim 1, wherein said system includes said first and second camera.

5. An apparatus for correcting for a vertical parallax in stereoscopic images of an object generated from a first video signal representative of a stream of first input image frames of such object which are captured by a first camera and a second video signal representative of a stream of second input image frames of such object which are captured by a second camera independently from such first camera, such second camera being juxtaposed with such first camera in a horizontal plane, said apparatus comprising:
(a) a first drive means which is coupled to such first camera for at least enabling linear movement thereof relative to such second camera; and
(b) a second drive means coupled to such second camera for tilting such second camera in a vertical plane.

6. The apparatus, according to claim 5, wherein said apparatus includes a base member and wherein each of said first and said second drive means is attached to said base member.

7. The apparatus, according to claim 6, wherein said apparatus further includes a cover member which is detachably attached to said base member for selectively exposing and covering said first and second drive means.

8. The apparatus, according to claim 5, wherein said first drive means includes:
(a) a first elongated guide;
(b) a second elongated guide which is fixed in spaced and parallel relationship to said first guide; and
(c) a camera which supports such first camera, said camera mount having a first end thereof operably engaging said first elongated guide and having a second end thereof operably engaging said second elongated guide.

9. The apparatus, according to claim 8, wherein said first elongated guide is a drive screw, wherein said first end of said camera mount includes a drive nut cooperating with said drive screw, and wherein said apparatus further includes a powered drive and a coupling means for coupling said powered drive to one end said drive screw so that said powered drives rotates said drive screw and linearly moves said first camera.

10. The apparatus, according to claim 5, wherein said second drive means includes:
(a) a shaft which is disposed horizontally and substantially perpendicular to optical axis of such second camera;
(b) a camera mount which is mounted for rotation about a longitudinal axis of said shaft and which supports such second camera; and
(c) a powered drive assembly connected to said camera mount for tilting it and such second camera in said vertical plane.

11. A method of correcting for a vertical parallax in stereoscopic images of an object generated from a combination of a first video signal representative of a stream of first input image frames of said object which are captured by a first camera and a second video signal representative of a stream of second input image frames of said object which are captured by a second camera independently from said first camera, said second camera being juxtaposed with said first camera in a horizontal plane, said method comprising the steps of:
(a) receiving, by a control means, said first video signal and said second video signal;
(b) analyzing, with said control means, said first input image frames and said second input image frames;
(c) calculating, with said control means, a value of said vertical parallax between corresponding first input image frames and said second input image frames;
(d) generating, with said control means, a correction control signal corresponding to said vertical parallax determined in step (c);
(e) receiving said correction control signal at a drive means connected to said control means and coupled to one of said first and second camera; and
(f) tilting said one of said first and second camera, by said drive means, in a vertical plane and in a direction which is opposite to said direction of said vertical parallax determined in step (c).

12. The method, according to claim 11, wherein said analyzing step includes the steps of:
(a) selecting a pair of corresponding image frames from said first input image frames and said second input image frames;
(b) determining, by said control means, a suitable image edge in one of said pair of corresponding image frames;
(c) determining, by said control means, a first image portion in said one of said first and said second image frames including said suitable image edge; and
(d) determining, by said control means, a second image portion in an opposed one of said first and said second image frames which is substantially identical to said first image portion.

13. The method, according to claim 12, wherein said calculating step includes the step of determining a magnitude of a vertical misalignment between said first image portion and said second image portion, said vertical misalignment being said vertical parallax and the step of determining a direction of said vertical misalignment.

14. The method, according to claim 12, wherein said method includes the additional step of merging said pair of corresponding image frames into a single image frame.

15. The method, according to claim 14, wherein said method includes the additional step of saving a copy of said single image frame to a memory.

16. The method, according to claim 11, wherein said method includes the additional step of determining a type of each of said first video signal and said second video signal and the step of converting each of said first video signal and second video signal of an analog type into a digital type.

17. The method, according to claim 11, wherein said method includes the additional step of saving a value of said vertical parallax to a memory.

18. A method of generating at least one stereoscopic image, said method comprising the steps of:
(a) positioning a first and a second camera in a horizontal plane and in a spaced relationship therebetween;
(b) generating, with said first camera, a first signal representative of a first input image of said object;
(c) generating, with said second camera, a second signal representative of a second input image of said object;
(d) analyzing, by said control means, said first signal and said second signal;
(e) determining, by said control means, a vertical parallax between said first signal and said second signal; and
(f) tilting one of said first and said second camera to correct said vertical parallax determined in step (e).

19. The method, according to claim 18, wherein said analyzing step includes the step of merging said first signal and said second signal into a single image frame in a side-by-side relationship, the step of saving a copy of said single image frame to memory, and the step of determining said vertical parallax within said saved copy.

20. The method, according to claim 18, wherein each of said first and said second signal is representative of one of a still input image frame and a stream of sequential input image frames of said object.
